(19) United States
(12) Patent Application Publication
(10) Pub. No.: US 2023/0420733 A1
(43) Pub. Date: Dec. 28, 2023

(54) ION CONDUCTIVE SOLID AND ALL-SOLID-STATE BATTERY

(71) Applicant: CANON OPTRON, INC., Ibaraki (JP)

(72) Inventors: Yoshitaka SHIBA, Tochigi (JP); Noriko SAKAMOTO, Tochigi (JP); Takeshi KOBAYASHI, Ibaraki (JP); Saori HASHIMOTO, Tochigi (JP)

(21) Appl. No.: 18/460,986

(22) Filed: Sep. 5, 2023

Related U.S. Application Data
(63) Continuation of application No. PCT/JP2021/045299, filed on Dec. 9, 2021.

(30) Foreign Application Priority Data
May 31, 2021 (JP) 2021-091056

(51) Int. Cl. H01M 10/0562

(52) U.S. Cl. CPC H01M 10/0562; H01M 2300/0077

(57) ABSTRACT

Provided are: an ion conductive solid which has high ion conductivity and can be produced by a heat treatment at a low temperature; and an all-solid-state battery having the same. Provided are: an ion conductive solid containing an oxide represented by general formula Li_{6-y-z}Y_{1-x-y-z}MₓZr_{y}Ce_{z}B₃O₉; and an all-solid-state battery having at least a positive electrode, a negative electrode, and an electrolyte, wherein at least one selected from the group consisting of the positive electrode, the negative electrode, and the electrolyte includes said ion conductive solid. (In the formula, M is at least one element selected from the group consisting of La, Pr, Nd, Sm, Eu, Gd, Tb, Dy, Ho, Er, Tm, Yb, and Lu. Moreover, x satisfies 0.005≤x≤0.800, y satisfies 0.000≤y≤0.400, z satisfies 0.000≤z≤0.400, and x, y, and z are real numbers satisfying 0.005≤x+y+z.)

### CROSS REFERENCE TO RELATED APPLICATIONS

This application is a Continuation of PCT International Application No. PCT/JP2021/045299, filed on Dec. 9, 2021, which is claiming priority of Japanese Patent Application No. 2021-091056, filed on May 31, 2021, all of which are hereby expressly incorporated by reference into the present application.

### BACKGROUND OF THE INVENTION

### Field of the Invention

The present disclosure relates to an ion-conductive solid and to an all-solid-state battery.

### Description of the Related Art

Lightweight and high-capacity lithium ion secondary batteries have come to be mounted in mobile devices such as smartphones and notebook computers, and in transport equipment such as electric vehicles and hybrid electric vehicles.

However, conventional lithium ion secondary batteries utilize electrolytes in the form of liquids that contain flammable solvents, which accordingly entails the risk of leakage of the flammable solvent and the risk of fire at the time of a battery short circuit. For the purpose of ensuring safety, therefore, secondary batteries that utilize electrolytes in the form of ion-conductive solids, different from liquid electrolytes, have attracted attention in recent years; such secondary batteries are referred to as all-solid-state batteries.

Solid electrolytes such as oxide-based solid electrolytes and sulfide-based solid electrolytes are widely known as electrolytes used in all-solid-state batteries. Among the foregoing, oxide-based solid electrolytes do not generate hydrogen sulfide by reacting with atmospheric moisture, and hence are safer than sulfide-based solid electrolytes.

An all-solid-state battery has a positive electrode containing a positive electrode active material, a negative electrode containing a negative electrode active material, an electrolyte containing an ion-conductive solid, disposed between the positive electrode and the negative electrode, and, as needed, a collector (the positive electrode active material and the negative electrode active material are hereafter also referred collectively to as “electrode active material”). In a case where an all-solid-state battery is produced using an oxide-based solid electrolyte, a heat treatment is performed for the purpose of reducing contact resistance between particles of the oxide-based material contained in the solid electrolyte. However, conventional oxide-based solid electrolytes require a high temperature, of 900° C. or above, in a heat treatment, and hence the solid electrolyte and the electrode active material may react and form thereby a high-resistance phase. This high-resistance phase may give rise to decreased ionic conductivity of the ion-conductive solid, which in turn may result in a drop of output of the all-solid-state battery.

Examples of oxide-based solid electrolytes that can be produced as a result of a heat treatment at a temperature lower than 900° C. include Li₂₊ₓC₁₋ₓBₓO₃ (Solid State Ionic 288 (2016) 248-252).

### SUMMARY OF THE INVENTION

The present disclosure provides an ion-conductive solid that can be produced as a result of a heat treatment at low temperature, and that exhibits high ionic conductivity, and provides an all-solid-state battery having that ion-conductive solid.

An ion-conductive solid of the present disclosure is an ion-conductive solid comprising an oxide represented by Formula Li_{6-y-z}Y_{1-x-y-z}MₓZr_{y}Ce_{z}B₃O₉,
wherein in the formula, M is at least one element selected from the group consisting of La, Pr, Nd, Sm, Eu, Gd, Tb, Dy, Ho, Er, Tm, Yb and Lu; and x, y and z are real numbers satisfying 0.005≤x≤0.800, 0.000≤y≤0.400, 0.000≤z≤0.400, and 0.005≤x+y+z<1.000.

Further, an all-solid-state battery of the present disclosure is an all-solid-state battery, comprising at least:
a positive electrode;
a negative electrode; and
an electrolyte,
wherein at least one selected from the group consisting of the positive electrode, the negative electrode and the electrolyte comprises the ion-conductive solid of the present disclosure.

One aspect of the present disclosure allows providing an ion-conductive solid that can be produced as a result of a heat treatment at low temperature, and that exhibits high ionic conductivity, and an all-solid-state battery having that ion-conductive solid. Further features of the present disclosure will become apparent from the following description of exemplary embodiments.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints.

In a case where numerical value ranges are described in stages, the upper limits and the lower limits of the respective numerical value ranges can be combined arbitrarily.

In the present disclosure, the term “solid” refers to a state of matter exhibiting a constant shape and volume, from among the three states of matter; the term “solid” encompasses also a powder state.

The ion-conductive solid of the present disclosure is an ion-conductive solid containing an oxide represented by Formula Li_{6-y-z}Y_{1-x-y-z}MₓZr_{y}Ce_{z}B₃O₉.

In the formula, M is at least one element selected from the group consisting of La, Pr, Nd, Sm, Eu, Gd, Tb, Dy, Ho, Er, Tm, Yb and Lu. Further, x, y and z are real numbers satisfying 0.005≤x≤0.800, 0.000≤y≤0.400, 0.000≤z≤0.400, and 0.005≤x+y+z<1.000.

Preferably, the ion-conductive solid of the present disclosure has a monoclinic crystal structure. When the ion-conductive solid has a monoclinic crystal structure, the lattice constant is affected to a greater degree, and lattice volume and ionic conductivity are further affected thereby, than is the case for Li₆YB₃O₉ that does not contain M, Zr or Ce (i.e., where x=0.000, y=0.000 and z=0.000).

In an X-ray diffraction analysis (hereafter also simply referred to as “XRD”) using CuKα rays, a diffraction peak appearing in the vicinity of 2θ=28° can vary depending on the composition of the above-described ion-conductive solid.

The ion-conductive solid of the present disclosure preferably exhibits a diffraction peak in the range 27.95°≤2θ≤28.10°, more preferably a diffraction peak in the range 27.98°≤2θ≤28.03°, and yet more preferably a diffraction peak in the range 27.99°≤2θ≤28.02°, in XRD using CuKα rays.

The position of the diffraction peak appearing in the vicinity of 2θ=28° in XRD using CuKα rays can be controlled by modifying the element represented by M in the above formula or modifying combinations of the elements, and by adjusting the values of x, y and z.

A lattice volume V of the ion-conductive solid of the present disclosure is preferably 753.00 Å³≤V≤756.00 Å3, more preferably 753.55 Å³≤V≤755.76 Å³, and yet more preferably 753.55 Å³≤V≤755.50 Å³.

The lattice volume of the ion-conductive solid can be controlled by modifying the element represented by M in the above formula or modifying combinations of the elements, and by adjusting the values of x, y and z. Elements represented by M in the formula above belong to lanthanoid elements. Lanthanoid elements have similar properties, and hence similar effects can be achieved with element combinations, or with numerical ranges of x, y, and z, other than those in the examples.

Specifically, M is at least one element selected from the group consisting of La, Pr, Nd, Sm, Eu, Gd, Tb, Dy, Ho, Er, Tm, Yb and Lu. Further, M may represent a single element or two or more elements.

The ion-conductive solid of the present disclosure may contain an oxide that includes Mg, Al, Sn, Hf, C and/or Nb, so long as desired effects are not impaired thereby.

In the above formula, x is a real number satisfying 0.005≤x≤0.800.

Herein x is 0.005≤x≤0.800, preferably 0.010≤x≤0.800, more preferably 0.010≤x≤0.400, yet more preferably 0.010≤x≤0.100, particularly preferably 0.010≤x≤0.050, and especially preferably 0.010≤x≤0.030.

In the above formula, y is a real number satisfying 0.000≤y≤0.400.

Herein y is 0.000≤y≤0.400, preferably 0.010≤y≤0.200, more preferably 0.010≤y≤0.100, and particularly preferably 0.030≤y≤0.100.

In the above formula, z is a real number satisfying 0.000≤z≤0.400.

Herein z is 0.000≤z≤0.400, preferably 0.010≤z≤0.200, more preferably 0.010≤z≤0.100 and particularly preferably 0.010≤z≤0.030.

In the above formula, x+y+z is a real number satisfying 0.005≤x+y+z<1.000.

Herein x+y+z is 0.005≤x+y+z<1.000, preferably 0.010≤x+y+z<1.000, more preferably 0.010≤x+y+z≤0.900, yet more preferably 0.010≤x+y+z≤0.400, particularly preferably 0.010≤x+y+z≤0.300, especially preferably 0.010≤x+y+z≤0.300, and most preferably 0.010≤x+y+z≤0.200.

The ion-conductive solid of the present disclosure can be embodied for instance as follows, but is not limited to embodiments below.
(1)

It suffices that x satisfies 0.010≤x≤0.100, y satisfies 0.000≤y≤0.200, z satisfies 0.000≤z≤0.200, and x, y and z satisfy 0.010≤x+y+z≤0.300.
(2)

It suffices that x satisfies 0.010≤x≤0.030, y satisfies 0.030≤y≤0.100, z satisfies 0.010≤z≤0.030, and x, y and z satisfy 0.050≤x+y+z≤0.160.

A method for producing the ion-conductive solid of the present disclosure will be explained next.

The method for producing an ion-conductive solid of the present disclosure can be implemented in the manner below, but is not limited thereto.

The method for producing an ion-conductive solid comprising an oxide represented by Formula Li_{6-y-z}Y_{1-x-y-z}MₓZr_{y}Ce_{z}B₃O₉ may have
a primary baking step of heat-treating a starting material, resulting from mixing so that the oxide represented by the above formula is obtained, at a temperature below the melting point of the oxide.

In the formula, M is at least one element selected from the group selected from among La, Pr, Nd, Sm, Eu, Gd, Tb, Dy, Ho, Er, Tm, Yb and Lu. Further, x, y and z are real numbers satisfying 0.005≤x≤0.800, 0.000≤y≤0.400, 0.000≤z≤0.400, and 0.005≤x+y+z<1.000.

The method for producing an ion-conductive solid of the present disclosure can include a primary baking step of weighing and mixing starting materials so that the oxide represented by the above formula is obtained, and heat-treating the starting materials at a temperature below the melting point of the oxide, to produce as a result an ion-conductive solid containing the above oxide. The production method may include a secondary baking step of heat-treating the obtained ion-conductive solid containing the oxide at a temperature below the melting point of the oxide, to produce a sintered compact of the ion-conductive solid containing the above oxide.

The method for producing an ion-conductive solid of the present disclosure including the above primary baking step and secondary baking step will be explained in detail below, but the present disclosure is not limited to the below-described production method.

Primary Baking Step

In the primary baking step, starting materials such as chemical reagent-grade Li₃BO₃, H₃BO₃, Y₂O₃, ZrO₂, CeO₂, Gd₂O₃, Nd₂O₃, Sm₂O₃, Eu₂O₃, Pr₂O₃, Tb₂O₃, Dy₂O₃, Ho₂O₃, Er₂O₃, Tm₂O₃, Lu₂O₃, Yb₂O₃ and/or La₂O₃ are stoichiometrically weighed and mixed so that Formula Li_{6-y-z}Y_{1-x-y-z}MₓZr_{y}Ce_{z}B₃O₉ is achieved (where x, y and z are real numbers satisfying 0.005≤x≤0.800, 0.000≤y≤0.400, 0.000≤z≤0.400, and 0.005≤x+y+z<1.000).

The apparatus used for mixing is not particularly limited, and for instance a pulverizing mixer such as a planetary ball mill can be used. The material and capacity of a container used for mixing, and the material and diameter of balls, are not particularly limited, and can be selected as appropriate depending on the types and amounts of the starting materials that are used. As an example, a 45 mL container made of zirconia, and 5 mm-diameter balls made of zirconia can be used herein. The conditions for the mixing treatment are not particularly limited, but may involve setting for instance revolutions from 50 rpm to 2000 rpm and a duration from 10 minutes to 60 minutes.

Once a mixed powder of the above starting materials has been obtained as a result of the mixing treatment, the obtained mixed powder is thereafter press-molded into pellets. The pressure molding method that is resorted to can be a known pressure molding method such as cold uniaxial molding or cold isostatic pressure molding. The pressure molding conditions in the primary baking step are not particularly limited, but for instance may involve a pressure set to from 100 MPa to 200 MPa.

The obtained pellets are baked using a baking apparatus such as an atmospheric baking apparatus. The temperature at which solid-phase synthesis is elicited through primary baking is not particularly limited, so long as it is lower than the melting point of the ion-conductive solid represented by Formula Li_{6-y-z}Y_{1-x-y-z}MₓZr_{y}Ce_{z}B₃O₉. The temperature at the time of the primary baking can be for instance lower than 700° C., or 680° C. or lower, or 670° C. or lower, or 660° C. or lower, or 650° C. or lower, and can be for instance 500° C. or higher. The above numerical value ranges can be combined arbitrarily. Solid-phase synthesis can be sufficiently elicited if the temperature lies within the above ranges. The duration of the primary baking step is not particularly limited, but can be for instance from about 700 minutes to 750 minutes.

Through the above primary baking step there can be produced the ion-conductive solid comprising an oxide represented by Formula Li_{6-y-z}Y_{1-x-y-z}MₓZr_{y}Ce_{z}B₃O₉. A powder of the ion-conductive solid comprising the above oxide can also be obtained through pulverization of the ion-conductive solid comprising the above oxide, using a mortar/pestle or a planetary mill.

Secondary Baking Step

In the secondary baking step, at least one selected from the group consisting of the ion-conductive solid comprising an oxide obtained in the primary baking step and a powder of the ion-conductive solid comprising an oxide is pressure-molded and is baked, to yield a sintered compact of the ion-conductive solid comprising an oxide of the present disclosure.

Pressure molding and secondary baking may be performed simultaneously for instance by spark plasma sintering (hereafter also simply referred to as “SPS”) or hot pressing; alternatively, pellets may be produced by cold uniaxial molding, and may be thereafter baked for instance in the ambient atmosphere, an oxidizing atmosphere or a reducing atmosphere. Under the above conditions an ion-conductive solid of high ionic conductivity can be obtained that does not result in melting on account of a heat treatment. The pressure molding conditions in the secondary baking step are not particularly limited, but for instance may involve a pressure from 10 MPa to 100 MPa.

The secondary baking temperature is lower than the melting point of the ion-conductive solid represented by Formula Li_{6-y-z}Y_{1-x-y-z}MₓZr_{y}Ce_{z}B₃O₉. The secondary baking temperature is preferably lower than 700° C., more preferably 680° C. or lower, yet more preferably 670° C. or lower, and particularly preferably 660° C. or lower. The lower limit of the temperature is not particularly restricted, and may be for instance 500° C. or higher, although the lower the limit, the better the limit is. The above numerical value ranges can be combined arbitrarily, and for instance the temperature at the time of secondary baking may be set to lie in the range from 500° C. to less than 700° C. Within the above ranges it becomes possible to suppress melting or decomposition of the ion-conductive solid containing an oxide of the present disclosure in the secondary baking step, and to obtain a sintered compact of the ion-conductive solid containing an oxide of the present disclosure having been sufficiently sintered. The duration of the secondary baking step can be modified as appropriate for instance in accordance with the secondary baking temperature, but is preferably 24 hours or shorter, and may be set to 1 hour or shorter. The duration of the secondary baking step may be for instance 5 minutes or longer.

The method for cooling the sintered compact of the ion-conductive solid containing an oxide of the present disclosure obtained as a result of the secondary baking step is not particularly limited, and may involve natural cooling (in-furnace cooling), or rapid cooling; alternatively, cooling more gradual than natural cooling, or a certain temperature may be held during cooling.

An all-solid-state battery of the present disclosure will be explained next.

An all-solid-state battery ordinarily has a positive electrode, a negative electrode, an electrolyte containing an ion-conductive solid, disposed between the positive electrode and the negative electrode, and, as needed, a collector.

The all-solid-state battery of the present disclosure is
an all-solid-state battery comprising at least
a positive electrode;
a negative electrode; and
an electrolyte;
wherein at least one selected from the group consisting of the positive electrode, the negative electrode and the electrolyte comprises the ion-conductive solid of the present disclosure.

The all-solid-state battery of the present disclosure may be a bulk-type battery or a thin-film battery. The concrete shape of the all-solid-state battery of the present disclosure is not particularly limited, and examples thereof include a coin shape, a button shape, a sheet shape and a multilayer shape.

The all-solid-state battery of the present disclosure comprises an electrolyte. In the all-solid-state battery of the present disclosure, preferably, at least the electrolyte comprises the ion-conductive solid of the present disclosure.

The solid electrolyte in the all-solid-state battery of the present disclosure may be made up of the ion-conductive solid of the present disclosure, may comprise another ion-conductive solid, and may comprise an ionic liquid and/or a gel polymer. The other ion-conductive solid is not particularly limited, and may include an ion-conductive solid ordinarily used in all-solid-state batteries, for instance LiI, Li₃PO₄ or Li₇La₃Zr₂O₁₂. The content of the ion-conductive solid of the present disclosure in the electrolyte in the all-solid-state battery of the present disclosure is not particularly limited, and is preferably 25 mass % or higher, more preferably 50 mass % or higher, yet more preferably 75 mass % or higher, and is particularly preferably 100 mass %.

The all-solid-state battery of the present disclosure comprises a positive electrode. The positive electrode may include a positive electrode active material, and may include the positive electrode active material and the ion-conductive solid of the present disclosure. A known positive electrode active material such as a sulfide containing a transition metal element or an oxide containing lithium and a transition metal element may be used, without particular limitations, as the positive electrode active material.

The positive electrode may further contain a binder, a conductive agent and the like. Examples of the binder include for instance polyvinylidene fluoride, polytetrafluoroethylene and polyvinyl alcohol. Examples of the conductive agent include for instance natural graphite, artificial graphite, acetylene black and ethylene black.

The all-solid-state battery of the present disclosure comprises a negative electrode. The negative electrode may include a negative electrode active material, and may include the above negative electrode active material and the ion-conductive solid of the present disclosure. Known negative electrode active materials, for instance inorganic compounds such as lithium, lithium alloys or tin compounds, carbonaceous materials capable of absorbing and releasing lithium ions, and conductive polymers can be used, without particular limitations, as the negative electrode active material.

The negative electrode may further contain a binder, a conductive agent and the like. Binders and conductive agents similar to those exemplified for the positive electrode may be used herein as the binder and the conductive agent.

The wording to the effect that the electrode “includes” an electrode active material signifies that the electrode has an electrode active material as a component/element/property. For instance, the wording “includes” applies both to an instance where the electrode contains the electrode active material in the interior, and to an instance where the surface of the electrode is coated with the electrode active material.

The positive electrode and the negative electrode can be obtained in accordance with known methods that involve for instance mixing of starting materials, molding, and a heat treatment. As a result, the ion-conductive solid gets for instance into gaps between electrode active material particles, which is deemed to make it easier to secure conduction paths for lithium ions. The ion-conductive solid of the present disclosure can be produced through a heat treatment at a lower temperature than in conventional art, which is deemed to allow suppressing as a result formation of a high-resistance phase derived from reactions between the ion-conductive solid and the electrode active material.

The positive electrode and the negative electrode may have a collector. As the collector there can be used a known collector, for instance of aluminum, titanium, stainless steel, nickel, iron, baked carbon, a conductive polymer or conductive glass. For the purpose of enhancing the adhesion, conductivity, oxidation resistance and the like, a collector can be used that has been treated for instance with carbon, nickel, titanium or silver.

The all-solid-state battery of the present disclosure can be obtained in accordance with a known method that involves for instance laying up of a positive electrode, a solid electrolyte and a negative electrode, and performing molding and a heat treatment. Given that the ion-conductive solid of the present disclosure can be produced in accordance with a heat treatment at a lower temperature than in conventional instances, it is considered that formation of a high-resistance phase derived from reactions between the ion-conductive solid and the electrode active material can be accordingly suppressed; it is thus deemed that an all-solid-state battery can be obtained that boasts excellent output characteristics.

An explanation follows next on measurement methods of compositions and of various physical properties according to the present disclosure.

Methods for Identifying and Analyzing Zr, Ce and M

A composition analysis of the ion-conductive solid is performed by wavelength-dispersive X-ray fluorescence analysis (hereafter also referred to as XRF) using a sample solidified by pressure molding. In a case where the analysis is difficult for instance due to a granularity effect, the ion-conductive solid may be made into glass, in accordance with a glass bead method, the glass being then subjected to a composition analysis by XRF. The composition analysis may be performed by inductively coupled high-frequency plasma atomic emission spectrometry (ICP-AES) or by inductively coupled plasma mass spectrometry (ICP-MS) in a case where yttrium peaks, and peaks of Zr, Ce and the element represented by M, overlap each other in XRF.

The analyzer ZSX Primus II by Rigaku Corporation is used in the case of XRF. The analysis conditions include using Rh in the anode of the X-ray tube, a vacuum atmosphere, an analysis diameter of 10 mm, an analysis range from 17 deg to 81 deg, a step of 0.01 deg, and a scan speed of 5 sec/step. Detection is accomplished using a proportional counter in measurements of light elements, and a scintillation counter in measurements of heavy elements.

Elements are identified on the basis of peak positions in the spectrum obtained by XRF; molar concentration ratios of Y/Zr, Y/Ce and Y/M are calculated from count rates (units: cps) which are numbers of X-ray photons per unit time, to work out x, y and z.

### EXAMPLES

Illustrative instances in which the ion-conductive solid of the present disclosure was specifically produced and evaluated will be explained next as examples. The present disclosure is however not limited to the examples below.

### Example 1

Primary Baking Step

Herein Li₃BO₃ (by Toshima Manufacturing Co., Ltd., purity 99.9 mass %), H₃BO₃ (by Kanto Chemical Co., purity 99.5%), Y₂O₃ (by Shin-Etsu Chemical Co., Ltd., purity 99.9 mass %) and Gd₂O₃ (by Shin-Etsu Chemical Co., Ltd., purity 99.9%), used as starting materials, were weighed stoichiometrically so as to yield Li_{6.000}Y_{0.990}Gd_{0.010}B₃O₉, and were mixed for 30 minutes in a planetary mill P-7, by Fritsch GmbH, at a disc rotational speed of 300 rpm. Zirconia φ5 mm balls and a 45 mL container were used in the planetary mill.

After mixing, the resulting mixed powder was subjected to cold uniaxial molding at 147 MPa using a 100 kN electric press P3052-10, by NPa System Co., Ltd., and was baked in the ambient atmosphere. The heating temperature was set to 650° C. and the holding time to 720 minutes.

The obtained ion-conductive solid containing an oxide was pulverized using a planetary mill P-7 by Fritsch GmbH for 180 minutes at a disk rotation speed of 230 rpm, to prepare a powder of the ion-conductive solid containing an oxide.

Secondary Baking Step

The obtained powder of the ion-conductive solid containing an oxide was molded and subjected to secondary baking, to produce a sintered compact of the ion-conductive solid containing an oxide of Example 1. Secondary baking was carried out in the ambient atmosphere at a heating temperature of 650° C. and over a holding time of 720 minutes.

### Examples 2 to 6

Sintered compacts of ion-conductive solids containing an oxide of Examples 2 to 6 were produced in accordance with the same process as in Example 1, but weighing stoichiometrically the above starting materials so that x took on herein the values given in Table 1.

### Example 7

A sintered compact of the ion-conductive solid containing an oxide of Example 7 was produced in accordance with the same process as in Example 1, but using Li₃BO₃ (by Toshima Manufacturing Co., Ltd., purity 99.9 mass %), H₃BO₃ (by Kanto Chemical Co., purity 99.5%), Y₂O₃ (by Shin-Etsu Chemical Co., Ltd., purity 99.9 mass %), Gd₂O₃ (by Shin-Etsu Chemical Co., Ltd., purity 99.9%) and ZrO₂ (by Nippon Denko Co., Ltd., purity 99.9%) as starting materials that were weighed stoichiometrically so as to yield herein Li_{5.500}Y_{0.775}Gd_{0.02}Zr_{0.200}B₃O₉.

### Example 8

A sintered compact of the ion-conductive solid containing an oxide of Example 8 was produced in accordance with the same process as in Example 7, but weighing stoichiometrically the above starting materials so that x and y took on herein the values given in Table 1.

### Example 9

A sintered compact of the ion-conductive solid containing an oxide of Example 9 was produced in accordance with the same process as in Example 1, but using Li₃BO₃ (by Toshima Manufacturing Co., Ltd., purity 99.9 mass %), H₃BO₃ (by Kanto Chemical Co., purity 99.5%), Y₂O₃ (by Shin-Etsu Chemical Co., Ltd., purity 99.9 mass %), Gd₂O₃ (by Shin-Etsu Chemical Co., Ltd., purity 99.9%) and CeO₂ (by Shin-Etsu Chemical Co., Ltd., purity 99.9%) as starting materials that were weighed stoichiometrically so as to yield herein Li_{5.500}Y_{0.775}Gd_{0.02}Zr_{0.200}B₃O₉.

### Example 10

A sintered compact of the ion-conductive solid containing an oxide of Example 10 was produced in accordance with the same process as in Example 9, but weighing stoichiometrically the above starting materials so that x and z took on herein the values given in Table 1.

### Example 11

A sintered compact of the ion-conductive solid containing an oxide of Example 11 was produced in accordance with the same process as in Example 1, but using Li₃BO₃ (by Toshima Manufacturing Co., Ltd., purity 99.9 mass %), H₃BO₃ (by Kanto Chemical Co., purity 99.5%), Y₂O₃ (by Shin-Etsu Chemical Co., Ltd., purity 99.9 mass %), Gd₂O₃ (by Shin-Etsu Chemical Co., Ltd., purity 99.9%) ZrO₂ (by Nippon Denko Co., Ltd., purity 99.9%) and CeO₂ (by Shin-Etsu Chemical Co., Ltd., purity 99.9%) as starting materials that were weighed stoichiometrically so as to yield herein Li_{5.875}Y_{0.850}Gd_{0.005}Zr_{0.100}Ce_{0.025}B₃O₉.

### Example 12

A sintered compact of the ion-conductive solid containing an oxide of Example 12 was produced in accordance with the same process as in Example 1, but using Li₃BO₃ (by Toshima Manufacturing Co., Ltd., purity 99.9 mass %), H₃B O₃ (by Kanto Chemical Co., purity 99.5%), Y₂O₃ (by Shin-Etsu Chemical Co., Ltd., purity 99.9 mass %), Gd₂O₃ (by Shin-Etsu Chemical Co., Ltd., purity 99.9%) and Nd₂O₃ (by Shin-Etsu Chemical Co., Ltd., purity 99.9%) as starting materials that were weighed stoichiometrically so as to yield herein Li_{6.000}Y_{0.950}Gd_{0.025}Nd_{0.025}B₃O₉.

### Example 13

A sintered compact of the ion-conductive solid containing an oxide of Example 13 was produced in accordance with the same process as in Example 1, but using Li₃BO₃ (by Toshima Manufacturing Co., Ltd., purity 99.9 mass %), H₃B O₃ (by Kanto Chemical Co., purity 99.5%), Y₂O₃ (by Shin-Etsu Chemical Co., Ltd., purity 99.9 mass %), Sm₂O₃ (by Nacalai Tesque Inc.) Eu₂O₃ (by Shin-Etsu Chemical Co., Ltd., purity 95%), ZrO₂ (by Nippon Denko Co., Ltd., purity 99.9%) and CeO₂ (by Shin-Etsu Chemical Co., Ltd., purity 99.9%) as starting materials that were weighed stoichiometrically so as to yield herein Li_{5.875}Y_{0.825}Sm_{0.025}Eu_{0.025}Zr_{0.100}Ce_{0.025}B₃O₉.

### Example 14

A sintered compact of the ion-conductive solid containing an oxide of Example 14 was produced in accordance with the same process as in Example 1, but using Li₃BO₃ (by Toshima Manufacturing Co., Ltd., purity 99.9 mass %), H₃B O₃ (by Kanto Chemical Co., purity 99.5%), Y₂O₃ (by Shin-Etsu Chemical Co., Ltd., purity 99.9 mass %), Pr₂O₃ (by Shin-Etsu Chemical Co., Ltd., purity 99.9%), Tb₂O₃ (by Shin-Etsu Chemical Co., Ltd., purity 99.9%), ZrO₂ (by Nippon Denko Co., Ltd., purity 99.9%) and CeO₂ (by Shin-Etsu Chemical Co., Ltd., purity 99.9%) as starting materials that were weighed stoichiometrically so as to yield herein Li_{5.875}Y_{0.825}Pr_{0.025}Tb_{0.025}Zr_{0.100}Ce_{0.025}B₃O₉.

### Example 15

A sintered compact of the ion-conductive solid containing an oxide of Example 15 was produced in accordance with the same process as in Example 1, but using Li₃BO₃ (by Toshima Manufacturing Co., Ltd., purity 99.9 mass %), H₃BO₃ (by Kanto Chemical Co., purity 99.5%), Y₂O₃ (by Shin-Etsu Chemical Co., Ltd., purity 99.9 mass %), Dy₂O₃ (by Shin-Etsu Chemical Co., Ltd., purity 95%) ZrO₂ (by Nippon Denko Co., Ltd., purity 99.9%) and CeO₂ (by Shin-Etsu Chemical Co., Ltd., purity 99.9%) as starting materials that were weighed stoichiometrically so as to yield herein Li_{5.875}Y_{0.825}Pr_{0.025}Tb_{0.025}Zr_{0.100}Ce_{0.025}B₃O₉.

### Example 16

A sintered compact of the ion-conductive solid containing an oxide of Example 16 was produced in accordance with the same process as in Example 1, but using Li₃BO₃ (by Toshima Manufacturing Co., Ltd., purity 99.9 mass %), H₃BO₃ (by Kanto Chemical Co., purity 99.5%), Y₂O₃ (by Shin-Etsu Chemical Co., Ltd., purity 99.9 mass %), Ho₂O₃ (by Kojundo Chemical Lab. Co., Ltd., purity 99.9%) Er₂O₃ (by Shin-Etsu Chemical Co., Ltd., purity 95%), ZrO₂ (by Nippon Denko Co., Ltd., purity 99.9%) and CeO₂ (by Shin-Etsu Chemical Co., Ltd., purity 99.9%) as starting materials that were weighed stoichiometrically so as to yield herein Li_{5.875}Y_{0.825}Pr_{0.025}Tb_{0.025}Zr_{0.100}Ce_{0.025}B₃O₉.

### Example 17

A sintered compact of the ion-conductive solid containing an oxide of Example 17 was produced in accordance with the same process as in Example 1, but using Li₃BO₃ (by Toshima Manufacturing Co., Ltd., purity 99.9 mass %), H₃BO₃ (by Kanto Chemical Co., purity 99.5%), Y₂O₃ (by Shin-Etsu Chemical Co., Ltd., purity 99.9 mass %), Tm₂O₃ (by Kojundo Chemical Lab. Co., Ltd., purity 99.9%), Lu₂O₃ (by Kojundo Chemical Lab. Co., Ltd., purity 99.9%), ZrO₂ (by Nippon Denko Co., Ltd., purity 99.9%) and CeO₂ (by Shin-Etsu Chemical Co., Ltd., purity 99.9%) as starting materials that were weighed stoichiometrically so as to yield herein Li_{5.875}Y_{0.825}Pr_{0.025}Tb_{0.025}Zr_{0.100}Ce_{0.025}B₃O₉.

### Example 18

A sintered compact of the ion-conductive solid containing an oxide of Example 18 was produced in accordance with the same process as in Example 1, but using Li₃BO₃ (by Toshima Manufacturing Co., Ltd., purity 99.9 mass %), H₃BO₃ (by Kanto Chemical Co., purity 99.5%), Y₂O₃ (by Shin-Etsu Chemical Co., Ltd., purity 99.9 mass %), Yb₂O₃ (by Shin-Etsu Chemical Co., Ltd., purity 99.9%) ZrO₂ (by Nippon Denko Co., Ltd., purity 99.9%) and CeO₂ (by Shin-Etsu Chemical Co., Ltd., purity 99.9%) as starting materials that were weighed stoichiometrically so as to yield herein Li_{5.875}Y_{0.825}Pr_{0.025}Tb_{0.025}Zr_{0.100}Ce_{0.025}B₃O₉

### Example 19

A sintered compact of the ion-conductive solid containing an oxide of Example 19 was produced in accordance with the same process as in Example 1, but using Li₃BO₃ (by Toshima Manufacturing Co., Ltd., purity 99.9 mass %), H₃BO₃ (by Kanto Chemical Co., purity 99.5%), Y₂O₃ (by Shin-Etsu Chemical Co., Ltd., purity 99.9 mass %), La₂O₃ (by Shin-Etsu Chemical Co., Ltd., purity 99.9%), ZrO₂ (by Nippon Denko Co., Ltd., purity 99.9%) and CeO₂ (by Shin-Etsu Chemical Co., Ltd., purity 99.9%) as starting materials that were weighed stoichiometrically so as to yield herein Li_{5.875}Y_{0.825}Pr_{0.025}Tb_{0.025}Zr_{0.100}Ce_{0.025}B₃O₉.

### Example 20

A sintered compact of the ion-conductive solid containing an oxide of Example 20 was produced in accordance with the same process as in Example 1, but using Li₃BO₃ (by Toshima Manufacturing Co., Ltd., purity 99.9 mass %), H₃BO₃ (by Kanto Chemical Co., purity 99.5%), Y₂O₃ (by Shin-Etsu Chemical Co., Ltd., purity 99.9 mass %), Ho₂O₃ (by Kojundo Chemical Lab. Co., Ltd., purity 99.9%), ZrO₂ (by Nippon Denko Co., Ltd., purity 99.9%) and CeO₂ (by Shin-Etsu Chemical Co., Ltd., purity 99.9%) as starting materials that were weighed stoichiometrically so as to yield herein Li_{5.875}Y_{0.825}Pr_{0.025}Tb_{0.025}Zr_{0.100}Ce_{0.025}B₃O₉

### Example 21

A sintered compact of the ion-conductive solid containing an oxide of Example 21 was produced in accordance with the same process as in Example 20, but weighing stoichiometrically the above starting materials so that x, y and z took on herein the values given in Table 1.

### Examples 22 and 23

Sintered compacts of ion-conductive solids containing an oxide of Examples 22 and 23 were produced in accordance with the same process as in Example 18, but weighing stoichiometrically the above starting materials so that x, y and z took on herein the values given in Table 1.

### Comparative Example 1

Primary Baking Step

An ion-conductive solid and a powder of the ion-conductive solid were produced in accordance with the same process as in Example 1, but using Li₃BO₃ (by Toshima Manufacturing Co., Ltd., purity 99.9 mass %), H₃BO₃ (by Kanto Chemical Co., purity 99.5%) and Y₂O₃ (by Shin-Etsu Chemical Co., Ltd., purity 99.9 mass %) as starting materials that were weighed stoichiometrically so as to yield herein Li₆YB₃O₉.

Secondary Baking Step

A sintered compact of the ion-conductive solid containing an oxide of Comparative example 1 was produced through molding of a powder of the obtained ion-conductive solid by spark plasma sintering (SPS), with secondary baking. The heating temperature was set to 700° C., the pressure to 30 MPa, and the holding time to 10 minutes.

### Comparative Example 2

Primary Baking Step

A solid and a powder of the solid were produced in accordance with the same process as in Example 1, but using Li₃BO₃ (by Toshima Manufacturing Co., Ltd., purity 99.9 mass %), H₃BO₃ (by Kanto Chemical Co., purity 99.5%), ZrO₂ (by Nippon Denko Co., Ltd., purity 99.9%) and CeO₂ (by Shin-Etsu Chemical Co., Ltd., purity 99.9%) as starting materials that were weighed stoichiometrically so as to yield herein Li_{5.000}Zr_{0.800}Ce_{0.200}B₃O₉.

Secondary Baking Step

The powder of the solid obtained above was molded and subjected to secondary baking, to thereby produce the oxide-containing sintered compact of Comparative example 2. Secondary baking was carried out in the ambient atmosphere at a heating temperature of 550° C. and over a holding time of 720 minutes.

The ionic conductivity of the sintered compacts of Examples 1 to 23 and Comparative examples 1 and 2 was measured in accordance with the following method.

A method for measuring ionic conductivity is described below. Table 1 sets out the obtained evaluation results.

Measurement of Ionic Conductivity

Two large-area surfaces parallelly facing each other of each flat plate-shaped sintered compact of each ion-conductive solid containing an oxide, obtained through secondary baking, were polished using sandpaper. The dimensions of each flat-shaped sintered compact of the ion-conductive solid containing an oxide can be set to 0.9 cm×0.9 cm×0.05 cm, but are not limited thereto. Polishing involved initial polishing with #500 for 15 minutes to 30 minutes, subsequently with #1000 for 10 minutes to 20 minutes, and lastly with #2000 for 5 minutes to 10 minutes; polishing was deemed to be complete once there were no visible unevenness or scratches on the polished surface.

After polishing, a gold film was formed on the polished surface of each sintered compact of an ion-conductive solid containing an oxide using a sputtering apparatus SC-701 MKII ADVANCE by Sanyu Electron Co., Ltd. The film formation conditions included Ar as a process gas, a degree of vacuum from 2 Pa to 5 Pa, and a film formation time set to 5 minutes. After film formation, each measurement sample was subjected to an AC impedance measurement.

An impedance/gain phase analyzer SI1260 and a dielectric interface system 1296 (both by Solartron Analytical Inc.) or an impedance analyzer MTZ-35 (by Bio-Logic Science Instruments SAS) were used for measuring impedance; the measurement conditions included a temperature of 27° C., an amplitude of 20 mV, and a frequency from 0.1 Hz to 1 MHz.

The resistance of each sintered compact of the ion-conductive solid containing an oxide was calculated using a Nyquist plot obtained through impedance measurement, and using the AC analysis software ZView by Scribner Associates Inc. An equivalent circuit corresponding to each measurement sample was set in ZView, whereupon the equivalent circuit and the Nyquist plot were fitted and analyzed, to calculate the resistance of the sintered compact of the ion-conductive solid containing an oxide. Ionic conductivity was then calculated on the basis of the expression below using the calculated resistance, the thickness of the sintered compact of the ion-conductive solid containing an oxide and the electrode area.

Ionic conductivity (S/cm)=thickness (cm) of sintered compact of ion-conductive solid containing an oxide/(resistance (Ω) of sintered compact of ion-conductive solid containing an oxide×electrode area (cm²))

Results

Table 1 summarizes the stoichiometric amounts of starting materials (values of x, y and z in Formula Li_{6-y-z}Y_{1-x-y-z}MₓZr_{y}Ce_{z}B₃O₉) of the starting materials in the production of the ion-conductive solids containing an oxide, and ionic conductivity, in Examples 1 to 23 and Comparative examples 1 and 2.

The results of the above composition analyses revealed that all the sintered compacts of ion-conductive solids containing an oxide of Examples 1 to 23 and Comparative example 1 had compositions according to the stoichiometric amounts of starting materials given in Table 1. The sintered compacts of ion-conductive solids containing an oxide of Examples 1 to 23 were ion-conductive solids exhibiting high ionic conductivity even when having been baked at a temperature lower than 700° C. By contrast, the main crystalline structure of the sintered compact of Comparative example 2 was that of a mixture of ZrO₂ and CeO₂ used as starting materials.

TABLE 1

| Example | M | La | Pr | Nd | Sm | Eu | Gd | Tb | Dy | Ho | Er |
|---|---|---|---|---|---|---|---|---|---|---|---|
| Example 1 | Gd | 0.000 | 0.000 | 0.000 | 0.000 | 0.000 | 0.010 | 0.000 | 0.000 | 0.000 | 0.000 |
| Example 2 | Gd | 0.000 | 0.000 | 0.000 | 0.000 | 0.000 | 0.025 | 0.000 | 0.000 | 0.000 | 0.000 |
| Example 3 | Gd | 0.000 | 0.000 | 0.000 | 0.000 | 0.000 | 0.100 | 0.000 | 0.000 | 0.000 | 0.000 |
| Example 4 | Gd | 0.000 | 0.000 | 0.000 | 0.000 | 0.000 | 0.200 | 0.000 | 0.000 | 0.000 | 0.000 |
| Example 5 | Gd | 0.000 | 0.000 | 0.000 | 0.000 | 0.000 | 0.400 | 0.000 | 0.000 | 0.000 | 0.000 |
| Example 6 | Gd | 0.000 | 0.000 | 0.000 | 0.000 | 0.000 | 0.800 | 0.000 | 0.000 | 0.000 | 0.000 |
| Example 7 | Gd | 0.000 | 0.000 | 0.000 | 0.000 | 0.000 | 0.025 | 0.000 | 0.000 | 0.000 | 0.000 |
| Example 8 | Gd | 0.000 | 0.000 | 0.000 | 0.000 | 0.000 | 0.025 | 0.000 | 0.000 | 0.000 | 0.000 |
| Example 9 | Gd | 0.000 | 0.000 | 0.000 | 0.000 | 0.000 | 0.025 | 0.000 | 0.000 | 0.000 | 0.000 |
| Example 10 | Gd | 0.000 | 0.000 | 0.000 | 0.000 | 0.000 | 0.025 | 0.000 | 0.000 | 0.000 | 0.000 |
| Example 11 | Gd | 0.000 | 0.000 | 0.000 | 0.000 | 0.000 | 0.025 | 0.000 | 0.000 | 0.000 | 0.000 |
| Example 12 | Gd, Nd | 0.000 | 0.000 | 0.025 | 0.000 | 0.000 | 0.025 | 0.000 | 0.000 | 0.000 | 0.000 |
| Example 13 | Sm, Eu | 0.000 | 0.000 | 0.000 | 0.025 | 0.025 | 0.000 | 0.000 | 0.000 | 0.000 | 0.000 |
| Example 14 | Pr, Tb | 0.000 | 0.025 | 0.000 | 0.000 | 0.000 | 0.000 | 0.025 | 0.000 | 0.000 | 0.000 |
| Example 15 | Dy | 0.000 | 0.000 | 0.000 | 0.000 | 0.000 | 0.000 | 0.000 | 0.025 | 0.000 | 0.000 |
| Example 16 | Ho, Er | 0.000 | 0.000 | 0.000 | 0.000 | 0.000 | 0.000 | 0.000 | 0.000 | 0.025 | 0.025 |
| Example 17 | Tm, Lu | 0.000 | 0.000 | 0.000 | 0.000 | 0.000 | 0.000 | 0.000 | 0.000 | 0.000 | 0.000 |
| Example 18 | Yb | 0.000 | 0.000 | 0.000 | 0.000 | 0.000 | 0.000 | 0.000 | 0.000 | 0.000 | 0.000 |
| Example 19 | La | 0.025 | 0.000 | 0.000 | 0.000 | 0.000 | 0.000 | 0.000 | 0.000 | 0.000 | 0.000 |
| Example 20 | Ho | 0.000 | 0.000 | 0.000 | 0.000 | 0.000 | 0.000 | 0.000 | 0.000 | 0.010 | 0.000 |
| Example 21 | Ho | 0.000 | 0.000 | 0.000 | 0.000 | 0.000 | 0.000 | 0.000 | 0.000 | 0.800 | 0.000 |
| Example 22 | Yb | 0.000 | 0.000 | 0.000 | 0.000 | 0.000 | 0.000 | 0.000 | 0.000 | 0.000 | 0.000 |
| Example 23 | Yb | 0.000 | 0.000 | 0.000 | 0.000 | 0.000 | 0.000 | 0.000 | 0.000 | 0.000 | 0.000 |
| Comparative | None | 0.000 | 0.000 | 0.000 | 0.000 | 0.000 | 0.000 | 0.000 | 0.000 | 0.000 | 0.000 |
| example 1 | | | | | | | | | | | |
| Comparative | None | 0.000 | 0.000 | 0.000 | 0.000 | 0.000 | 0.000 | 0.000 | 0.000 | 0.000 | 0.000 |
| example 2 | | | | | | | | | | | |

| | | | | | | | | | | Ionic |
|---|---|---|---|---|---|---|---|---|---|---|
| | | | | | | | | | x + | conductivity |
| Example | Tm | Yb | Lu | Zr | Ce | x | y | z | y + z | (S/cm) |
| Example 1 | 0.000 | 0.000 | 0.000 | 0.000 | 0.000 | 0.010 | 0.000 | 0.000 | 0.010 | 2.41 × 10⁻¹⁰ |
| Example 2 | 0.000 | 0.000 | 0.000 | 0.000 | 0.000 | 0.025 | 0.000 | 0.000 | 0.025 | 3.73 × 10⁻¹⁰ |
| Example 3 | 0.000 | 0.000 | 0.000 | 0.000 | 0.000 | 0.100 | 0.000 | 0.000 | 0.100 | 4.34 × 10⁻¹⁰ |
| Example 4 | 0.000 | 0.000 | 0.000 | 0.000 | 0.000 | 0.200 | 0.000 | 0.000 | 0.200 | 2.07 × 10⁻¹⁰ |
| Example 5 | 0.000 | 0.000 | 0.000 | 0.000 | 0.000 | 0.400 | 0.000 | 0.000 | 0.400 | 3.84 × 10⁻¹⁰ |
| Example 6 | 0.000 | 0.000 | 0.000 | 0.000 | 0.000 | 0.800 | 0.000 | 0.000 | 0.800 | 1.86 × 10⁻¹⁰ |
| Example 7 | 0.000 | 0.000 | 0.000 | 0.200 | 0.000 | 0.025 | 0.200 | 0.000 | 0.225 | 5.03 × 10⁻⁶ |
| Example 8 | 0.000 | 0.000 | 0.000 | 0.400 | 0.000 | 0.025 | 0.400 | 0.000 | 0.425 | 1.49 × 10⁻⁶ |
| Example 9 | 0.000 | 0.000 | 0.000 | 0.000 | 0.200 | 0.025 | 0.000 | 0.200 | 0.225 | 2.57 × 10⁻⁸ |
| Example 10 | 0.000 | 0.000 | 0.000 | 0.000 | 0.400 | 0.025 | 0.000 | 0.400 | 0.425 | 1.49 × 10⁻⁹ |
| Example 11 | 0.000 | 0.000 | 0.000 | 0.100 | 0.025 | 0.025 | 0.100 | 0.025 | 0.150 | 4.77 × 10⁻⁶ |
| Example 12 | 0.000 | 0.000 | 0.000 | 0.000 | 0.000 | 0.050 | 0.000 | 0.000 | 0.050 | 3.95 × 10⁻¹⁰ |
| Example 13 | 0.000 | 0.000 | 0.000 | 0.100 | 0.025 | 0.050 | 0.100 | 0.025 | 0.175 | 5.12 × 10⁻⁶ |
| Example 14 | 0.000 | 0.000 | 0.000 | 0.100 | 0.025 | 0.050 | 0.100 | 0.025 | 0.175 | 3.63 × 10⁻⁶ |
| Example 15 | 0.000 | 0.000 | 0.000 | 0.100 | 0.025 | 0.025 | 0.100 | 0.025 | 0.150 | 5.17 × 10⁻⁶ |
| Example 16 | 0.000 | 0.000 | 0.000 | 0.100 | 0.025 | 0.050 | 0.100 | 0.025 | 0.175 | 2.28 × 10⁻⁶ |
| Example 17 | 0.025 | 0.000 | 0.025 | 0.100 | 0.025 | 0.050 | 0.100 | 0.025 | 0.175 | 6.89 × 10⁻⁶ |
| Example 18 | 0.000 | 0.025 | 0.000 | 0.100 | 0.025 | 0.025 | 0.100 | 0.025 | 0.150 | 5.33 × 10⁻⁶ |
| Example 19 | 0.000 | 0.000 | 0.000 | 0.100 | 0.025 | 0.025 | 0.100 | 0.025 | 0.150 | 2.61 × 10⁻⁶ |
| Example 20 | 0.000 | 0.000 | 0.000 | 0.100 | 0.025 | 0.010 | 0.100 | 0.025 | 0.135 | 8.58 × 10⁻⁶ |
| Example 21 | 0.000 | 0.000 | 0.000 | 0.100 | 0.025 | 0.800 | 0.100 | 0.025 | 0.925 | 9.96 × 10⁻¹⁰ |
| Example 22 | 0.000 | 0.010 | 0.000 | 0.100 | 0.025 | 0.010 | 0.100 | 0.025 | 0.135 | 7.57 × 10⁻⁶ |
| Example 23 | 0.000 | 0.800 | 0.000 | 0.100 | 0.025 | 0.800 | 0.100 | 0.025 | 0.925 | 7.29 × 10⁻¹⁰ |
| Comparative | 0.000 | 0.000 | 0.000 | 0.000 | 0.000 | 0.000 | 0.000 | 0.000 | 0.000 | 5.61 × 10⁻¹¹ |
| example 1 | | | | | | | | | | |
| Comparative | 0.000 | 0.000 | 0.000 | 0.800 | 0.200 | 0.000 | 0.800 | 0.200 | 1.000 | * |
| example 2 | | | | | | | | | | |

The note “*” in the ionic conductivity column signifies that ionic conductivity could not be measured due to high resistance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An ion-conductive solid comprising an oxide represented by Formula Li_{6-y-z}Y_{1-x-y-z}MₓZr_{y}Ce_{z}B₃O₉,
wherein in the formula, M is at least one element selected from the group consisting of La, Pr, Nd, Sm, Eu, Gd, Tb, Dy, Ho, Er, Tm, Yb and Lu; and x, y and z are real numbers satisfying 0.005≤x≤0.800, 0.000≤y≤0.400, 0.000≤z≤0.400, and 0.005≤x+y+z<1.000.

2. The ion-conductive solid according to claim 1, wherein the x is 0.010≤x≤0.800.

3. The ion-conductive solid according to claim 1, wherein the x is 0.010≤x≤0.400.

4. The ion-conductive solid according to claim 1, wherein the x is 0.010≤x≤0.200.

5. The ion-conductive solid according to claim 1, wherein the x+y+z is 0.010≤x+y+z≤0.900.

6. The ion-conductive solid according to claim 1, wherein the x+y+z is 0.010≤x+y+z≤0.400.

7. An all-solid-state battery, comprising at least:
a positive electrode;
a negative electrode; and
an electrolyte,
wherein at least one selected from the group consisting of the positive electrode, the negative electrode and the electrolyte comprises the ion-conductive solid according to claim 1.

8. The all-solid-state battery according to claim 7, wherein at least the electrolyte comprises the ion-conductive solid.
